(19) United States
(12) Patent Application Publication
(10) Pub. No.: US 2016/0255440 A1
(43) Pub. Date: Sep. 1, 2016

(54) Cosmetic Powder Compositions for Delivering Actives

(71) Applicant: Avon Products, Inc., Suffern, NY (US)

(72) Inventors: Raheel Khan, Franklin Park, NJ (US); Amitabh Bansal, Hoboken, NJ (US); Blanca Perez, Randolph, NJ (US)

(21) Appl. No.: 14/379,175

(22) PCT Filed: Feb. 26, 2014
(86) PCT No.: PCT/US14/18654

§ 371 Date: Aug. 15, 2014

Related U.S. Application Data
(60) Provisional application No. 61/791,427, filed on Mar. 15, 2013.

(51) Int. Cl. H04R 15/02; B06B 1/08; H04R 1/28

(52) U.S. Cl. CPC H04R 15/02; H04R 1/2888; B06B 1/08; H04R 2217/03

(57) ABSTRACT

The present invention relates generally to cosmetic powder compositions for topical application to a keratinous surface, as well as to the delivery of cosmetic actives using the cosmetic powder compositions. In particular, the cosmetic powder compositions of the present invention comprise actives for delivery to the skin, such actives providing aesthetic and therapeutic benefits to the skin, such as, by improving the condition and appearance of skin affected by signs of chronological, hormonal, or photo-aging.

### RELATED APPLICATION

This application claims priority benefit, under the national stage entry under 35 U.S.C. 371 of International Application No. PCT/US14/18654, filed on Feb. 26, 2014 the contents of which application are hereby incorporated by reference in their entirety. This application claims priority to U.S. Provisional Patent Application Ser. No. 61/791,427 filed Mar. 15, 2013, the contents of which are hereby incorporated by reference in their entirety.

### FIELD OF INVENTION

The present invention relates generally to cosmetic powder compositions for topical application to a keratinous surface, as well as to the delivery of cosmetic actives using the cosmetic powder compositions. In particular, the cosmetic powder compositions of the present invention comprise actives for delivery to the skin, such actives providing aesthetic and therapeutic benefits to the skin, such as, by improving the condition and appearance of skin affected by signs of chronological, hormonal, or photo-aging.

### BACKGROUND OF THE INVENTION

Powder-based cosmetics such as eye shadows and blushes typically comprise cosmetic particulates (e.g., pigments, fillers, talc, and mica) pressed into a cake with the aid of a dry or wet binder. However, the use of powder-based compositions has been limited to achieving optical effects and absorbing sebum. Unlike liquid cosmetic forms, however, powders have not been successfully used to deliver actives to the skin. There is therefore a need for powdered cosmetic compositions that can deliver effective amounts of cosmetic actives to the skin.

It is therefore an object of the invention to provide cosmetic powder compositions comprising active agents, as well as methods for delivering active agents to the skin comprising applying the cosmetic powder compositions to the skin. It is another object of the invention to provide cosmetic powder compositions that are capable of delivering effective amounts of active agents to the skin. It is a further object of the invention to provide powdered compositions and methods of using the same for combating signs of skin aging and to improve the overall appearance of skin.

### SUMMARY OF THE INVENTION

In accordance with the foregoing objectives and others, it has surprisingly been found that cosmetic actives can be delivered to the skin in effective amounts from powdered (e.g., non-liquid) vehicles. The powdered composition may be composed of a cosmetic particulate such as talc or mica, and may include additional cosmetic particulates such as pigments, lakes, fillers, polymeric powders, and the like. The cosmetic particulate material has an active agent (e.g., antioxidants, retinoids, depigmenting agents, anti-aging agents, humectants, etc.) and a liquid adsorbed, coated, or otherwise adhered to the surface of the particulates. The liquid is a solvent for the active and may suitably be any liquid that is safe and non-irritating for contact with a human integument. For example, the liquid may comprise a polyterpene oil, such as squalene, which is anticipated to improve transfer of the active to the skin and penetration of the active into the skin. The liquid is added in amounts effective to solubilize the active and facilitate transfer of the active to the skin, but no so much as to alter the free flowing characteristics of the powder. For example, the weight ratio of the particles to the liquid solvent may be about 9:1 to about 30:1, or about 15:1 to about 25:1, or from about 18:1 to about 22:1. The liquid may be applied to the powder by, for example, spraying it onto an agitated mass of the powder or mixing it with the powder under conditions of high shear or milling (e.g., in a ball mill).

The cosmetic powder composition may be, for example, in the form of a free flowing powder or a pressed powder cake which may include a binder. The composition is capable of transferring effective amounts of said active agents on rubbing the powder topically on a keratinous surface.

These cosmetic powder compositions are contemplated to be useful for delivering a variety of active agents that are beneficial in treating numerous skin disorders such as acne and blemishes, as well as signs of intrinsic aging and photo-aging of skin, skin hyperpigmentation, among others.

The active agent in the cosmetic powder compositions of the invention may comprise one or more of antioxidants, alpha-hydroxy acids, beta-hydroxy acids, retinoids, humectants, organic sunscreens, depigmenting agents, desqumating agent, anti-acne agents, anti-cellulite agents, collagenase inhibitors, elastase inhibitors, collagen stimulators, elastin stimulators, thiodipropionic acid and esters thereof, glycolic acid, N-Acetyl Tyrosinamide, and other anti-aging ingredients.

These and other aspects of the present invention will be better understood by reference to the following detailed description and appended claims.

### BRIEF DESCRIPTION OF THE DRAWINGS

FIG. 1 illustrates the concentration of caffeine found in forearm skin after having a cosmetic powder composition of the invention applied to the forearm.

### DETAILED DESCRIPTION OF THE INVENTION

All terms used herein are intended to have their ordinary meaning unless otherwise provided. All ingredient amounts provided herein are by weight percent of the total composition unless otherwise indicated. As used herein, the term “consisting essentially of” is intended to limit the invention to the specified materials or steps and those that do not materially affect the basic and novel characteristics of the claimed invention, as understood from a reading of this specification.

It has surprisingly been found that cosmetic actives can be delivered to keratinous surface such as the skin in effective amounts from powered (e.g., non-liquid) vehicles. Such active agents may be transferred from the compositions of the invention to a keratinous surface by, for example, applying the powder topically onto the keratinous surface. The actives are delivered to the skin in effective amounts, by which is meant amounts sufficient to accomplish the purpose for which the active is intended.

Without wishing to be bound by any particular theory, it believed that the actives are in equilibrium between an adsorbed state on the particles and in a solvated state in a thin layer of solvent coating the particles. When contacted with the skin, a second equilibrium between the solvated state and the skin is established. Moreover, the terpenoid oils solvents are believed to facilitate penetration of the actives into the skin, by softening the stratum corneum, thereby allowing the actives to be more efficiently delivered.

The cosmetic powder compositions comprise cosmetic particulates. In one embodiment, the cosmetic particulate includes talc. In another embodiment, the cosmetic particulate includes mica. The cosmetic particulates may include additional particulates such as pigments (e.g., pigments, pearls, and lakes), fillers, polymeric powders, and other cosmetic particulates. The talc and/or mica may comprise from 25% to 100% (or 50% to about 90%) by weight of the particulates. The pigments, fillers, and additional cosmetic powers may comprise from 1% to about 75% (or 10% to about 35%) by weight of the particulates.

Suitable pigments include those known in the art and may include those disclosed in the C.T.F.A. Cosmetic Ingredient Handbook, First Edition, 1988, the contents of which are hereby incorporated by reference. Exemplary pigments include, but are not limited to, metal oxides and metal hydroxides such as magnesium oxide, magnesium hydroxide, calcium oxide, calcium hydroxides, aluminum oxide, aluminum hydroxide, iron oxides (α-Fe₂O₃, β-Fe₂O₃, Fe₃O₄, FeO), red iron oxide, yellow iron oxide, black iron oxide, iron hydroxides, titanium dioxide, titanium lower oxides, zirconium oxides, chromium oxides, chromium hydroxides, manganese oxides, cobalt oxides, cerium oxides, nickel oxides and zinc oxides and composite oxides and composite hydroxides such as iron titanate, cobalt titanate and cobalt aluminate. Other suitable pigments include ultramarine blue (i.e., sodium aluminum silicate containing sulfur), Prussian blue, manganese violet and the like. The term “pigments” includes pearlescent or nacreous pigments. Suitable pearlescent agents may include, for example, bismuth oxychloride.

Suitable fillers may include talc, silica, zinc stearate, mica, kaolin, nylon (in particular orgasol) powder, polyethylene powder, polypropylene powder, acrylates powders, Teflon, starch, boron nitride, copolymer microspheres such as Expancel (Nobel Industrie), Polytrap (Dow Coming), and silicone resin microbeads (Tospearl from Toshiba).

Other fillers that may be used in the compositions of the invention include inorganic powders such as chalk, fumed silica, fumed alumina, calcium oxide, calcium carbonate, magnesium oxide, magnesium carbonate, Fuller's earth, attapulgite, bentonite, muscovite, phlogopite, synthetic mica, lepidolite, hectorite, biotite, lithia mica, vermiculite, aluminum silicate, aluminum magnesium silicate, diatomaceous earth, starch, alkyl and/or trialkyl aryl ammonium smectites, chemically modified magnesium aluminum silicate, organically modified montmorillonite clay, hydrated aluminum silicate, hydrated silica, fumed aluminum starch octenyl succinate barium silicate, calcium silicate, magnesium silicate, strontium silicate, metal tungstate, magnesium, silica alumina, zeolite, barium sulfate, calcined calcium sulfate (calcined gypsum), calcium phosphate, fluorine apatite, hydroxyapatite, ceramic powder, metallic soap (zinc stearate, magnesium stearate, zinc myristate, calcium palmitate, and aluminum stearate), colloidal silicon dioxide; organic powder, cyclodextrin, methyl polymethacrylate powder, copolymer powder of styrene and acrylic acid, benzoguanamine resin powder, and poly(ethylene tetrafluoride) powder.

The powders in the cosmetic powder compositions of the invention may comprise any shape (spherical, amorphous, platelet, etc.); particle structure (porous and non-porous), and size. The powders will typically have a median particle size greater than about 5 nm and less than about 300 microns, and more typically will range from about 0.1 microns to about 150 microns, and preferably from about 1 micron to about 75 microns. In one embodiment, the powder will have a multimodal particle size distribution. Interstitial spaces typically occur in powders having particles of equal diameter, and in powdered compositions these spaces may impair the delivery of actives by interrupting the substantial contact the cosmetic has with the underlying integument and reducing the surface area over which the liquid solvent may adsorb the active. Thus, it may be advantageous to have a powder with a multimodal size distribution to avoid air pockets and provide additional surface area over which the active may be adsorbed thereby enhancing the delivery of these actives to the surface of the underlying integument. The powder may have at least a bimodal particle size distribution, but trimodal and greater size distributions are contemplated as well. The smaller particles should be present in such quantity and size range to fit into the interstitial spaces between the larger particles as they pack together.

The cosmetic particulates have dispersed thereon an active agent and a liquid solvent for the active agent. The actives can be added first (i.e., dissolved or dispersed) in the liquid solvent. The mixture can then be sprayed onto, or admixed with the particulates. When it is sprayed onto the particulates, the mixture may be sprayed onto an agitated mass of the particulates, for example in a ribbon blender or the like. The liquid mixture can also be added to the particulates at once or slowly over a period of time, and the resulting composition mixed, for example under high shear or milling (e.g., in a ball mill) to uniformly disperse the liquid and active across the surface of the particles.

The weight ratio of the particles to the liquid solvent may be about 9:1 to about 30:1. In another embodiment, the weight ratio of the particles to the liquid solvent is about 10:1 to about 25:1. In other embodiments, the weight ratio of the particles to the liquid solvent is about 15:1 to about 25:1. In other embodiments, the weight ratio of the particles to the liquid solvent is about 18:1 to about 22:1.

The liquid solvent for the active and may suitably be any liquid that is safe and non-irritating for contact with a human integument. In some embodiments the solvent is a liquid terpenoid. The terpenoid may be a hemiterpene (e.g., prenol), a mono terpene (e.g., geraniol), a sesquiterpene (e.g., Farnesol), a triterpene (e.g., squalene), and the like. For example, the liquid may comprise a polyterpene oil, including polyterpenes of the form:

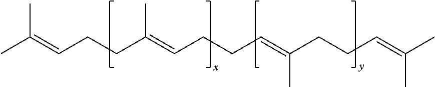

where x and y are independently 1-4. One example of such as polyterpene is squalene. Other polyterpene oils suitable for use as liquid solvents in the cosmetic powder compositions of the invention include terpenols, including those of the form:

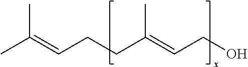

which is anticipated to improve transfer of the active to the skin and penetration of the active into the skin. Derivatives of terpenes, including phytol , are also contemplated.

In other embodiments, suitable liquid solvents are oils are selected from the group consisting of esters, particularly fatty acid esters; silicone oils; and hydrocarbons.

Ester oils include any non-polar or low-polarity ester, including fatty acid esters. Special mention may be made of those esters commonly used as emollients in cosmetic formulations. Such esters will typically be the etherification product of an acid of the form R₄(COOH)₁₋₂ with an alcohol of the form R₅(OH)₁₋₃ where R₄ and R₅ are each independently linear, branched, or cyclic hydrocarbon groups, optionally containing unsaturated bonds, and having from 1 to 30 carbon atoms, preferably from 2 to 30 carbon atoms, and more preferably, from 3 to 30 carbon atoms, optionally substituted with one or more functionalities including hydroxyl, oxa, oxo, and the like. Preferably, at least one of R₄ and R₅ comprises at least 8, and more preferably, at least 15, 16, 17, or 18 carbon atoms, such that the ester comprises at least one fatty chain. The esters defined above will include, without limitation, the esters of mono-acids with mono-alcohols, mono-acids with diols and triols, di-acids with mono-alcohols, and tri-acids with mono-alcohols.

Suitable fatty acid esters include, without limitation, butyl acetate, butyl isostearate, butyl oleate, butyl octyl oleate, cetyl palmitate, ceyl octanoate, cetyl laurate, cetyl lactate, cetyl isononanoate, cetyl stearate, diisostearyl fumarate, diisostearyl malate, neopentyl glycol dioctanoate, dibutyl sebacate, di-C.sub.12-13 alkyl malate, dicetearyl dimer dilinoleate, dicetyl adipate, diisocetyl adipate, diisononyl adipate, diisopropyl dimerate, triisostearyl trilinoleate, octodecyl stearoyl stearate, hexyl laurate, hexadecyl isostearate, hexydecyl laurate, hexyldecyl octanoate, hexyldecyl oleate, hexyldecyl palmitate, hexyldecyl stearate, isononyl isononanaote, isostearyl isononate, isohexyl neopentanoate, isohexadecyl stearate, isopropyl isostearate, n-propyl myristate, isopropyl myristate, n-propyl palmitate, isopropyl palmitate, hexacosanyl palmitate, lauryl lactate, octacosanyl palmitate, propylene glycol monolaurate, triacontanyl palmitate, dotriacontanyl palmitate, tetratriacontanyl palmitate, hexacosanyl stearate, octacosanyl stearate, triacontanyl stearate, dotriacontanyl stearate, stearyl lactate, stearyl octanoate, stearyl heptanoate, stearyl stearate, tetratriacontanyl stearate, triarachidin, tributyl citrate, triisostearyl citrate, tri-C.sub.12-13-alkyl citrate, tricaprylin, tricaprylyl citrate, tridecyl behenate, trioctyldodecyl citrate, tridecyl cocoate, tridecyl isononanoate, glyceryl monoricinoleate, 2-octyldecyl palmitate, 2-octyldodecyl myristate or lactate, di(2-ethylhexyl) succinate, tocopheryl acetate, and the like.

Other suitable esters include those wherein R₅ comprises a polyglycol of the form H—(O—CHR*-CHR*)n- wherein R* is independently selected from hydrogen or straight chain alkyl, including methyl and ethyl, as exemplified by polyethylene glycol monolaurate.

Salicylates and benzoates are also contemplated to be useful esters in the practice of the invention. Suitable salicylates and benzoates include esters of salicylic acid or benzoic acid with an alcohol of the form R₆OH where R₆ is a linear, branched, or cyclic hydrocarbon group, optionally containing unsaturated bonds, and having from 1 to 30 carbon atoms, preferably from 6 to 22 carbon atoms, and more preferably from 12 to 15 carbon atoms. Suitable salicylates include, for example, octyl salicylate and hexyldodecyl salicylate, and benzoate esters including C₁₂₋₁₅ alkyl benzoate, isostearyl benzoate, hexyldecyl benzoate, benzyl benzoate, and the like.

Other suitable esters include, without limitation, polyglyceryl diisostearate/IPDI copolymer, triisostearoyl polyglyceryl-3 dimer dilinoleate, polyglycerol esters of fatty acids, and lanolin, to name but a few.

The oil may also be a volatile or non-volatile silicone oil. Suitable silicone oils include linear or cyclic silicones such as polyalkyl- or polyarylsiloxanes, optionally comprising alkyl or alkoxy groups having from 1 to 10 carbon atoms. Representative silicone oils include, for example, caprylyl methicone, cyclomethicone, cyclopentasiloxane, decamethylcyclopentasiloxane, decamethyltetrasiloxane, diphenyl dimethicone, dodecamethylcyclohexasiloxane, dodecamethylpentasiloxane, heptamethylhexyltrisiloxane, heptamethyloctyltrisiloxane, hexamethyldisiloxane, methicone, methyl-phenyl polysiloxane, octamethylcyclotetrasiloxane, octamethyltrisiloxane, diphenyl dimethicone perfluorononyl dimethicone, polydimethylsiloxanes, and combinations thereof. The silicone oil will typically, but not necessarily, have a viscosity of between about 5 and about 3,000 centistokes (cSt), preferably between 50 and 1,000 cSt measured at 25° C.

In one embodiment of the invention, the silicone oil is a fluorinated silicone, preferably a perfluorinated silicone (i.e., fluorosilicones). Fluorosilicones are advantageously both hydrophobic and oleophobic and thus advantageously contribute to a desirable slip and feel of the product. Fluorosilicones also impart long-wearing characteristics to the product. The preferred fluorosilicone is a fluorinated organofunctional silicone fluid having the INCI name perfluorononyl dimethicone. Perfluorononyl dimethicone is commercially available from Phoenix Chemical under the trade name PECOSIL.

The liquid solvent may also comprise hydrocarbon oils. Exemplary hydrocarbon oils are straight or branched chain paraffinic hydrocarbons having from 5 to 80 carbon atoms, preferably from 8 to 40 carbon atoms, and more preferably from 10 to 16 carbon atoms, including but not limited to, pentane, hexane, heptane, octane, nonane, decane, undecane, dodecane, tetradecane, tridecane, and the like. Preferred hydrocarbon oils are highly branched aliphatic hydrocarbons, including C8-9 isoparaffins, C9-11 isoparaffins, C12 isoparaffin, and C20-40 isoparaffins and the like. Special mention may be made of the isoparaffins having the INCI names isohexadecane, isoeicosane, and isododecane.

Also suitable as hydrocarbon oils are polyalphaolefins, typically having greater than 20 carbon atoms, including C24-28 olefins, C30-45 olefins, hydrogenated polyisobutene, hydrogenated polydecene, polybutene, mineral oil, pentahydrosqualene, squalene, squalane, and the like. The hydrocarbon oil may also comprise higher fatty alcohols, such as oleyl alcohol, octyldodecanol, and the like.

Other suitable oils include without limitation castor oil, C10-18 triglycerides, caprylic/capric/triglycerides, coconut oil, corn oil, cottonseed oil, linseed oil, mink oil, olive oil, palm oil, illipe butter, rapeseed oil, soybean oil, sunflower seed oil, walnut oil, avocado oil, camellia oil, macadamia nut oil, turtle oil, mink oil, soybean oil, grape seed oil, sesame oil, maize oil, rapeseed oil, sunflower oil, cottonseed oil, jojoba oil, peanut oil, olive oil, and combinations thereof

Any one of the foregoing terpenoids, ester oils, silicone oils, and hydrocarbon oils are contemplated to be useful in the practice of the invention. Accordingly, in one embodiment, the compositions comprise at least one oil selected from the terpenoids, ester oils, silicone oils, and hydrocarbon oils described above. In one embodiment, the liquid solvent will comprise a terpenoid, optionally in combination with at least one additional oil selected from hydrocarbon oils, silicone oils, and combinations thereof

The liquid is added in amounts effective to solubilize the active and facilitate transfer of the active to the skin, but no so much as to alter the free flowing characteristics of the powder. The cosmetic powder composition may be in the form of a pourable, free flowing powder. In some embodiments, the cosmetic particulate substantially retains its flow properties after addition of the liquid solvent and active. In other embodiments, the cosmetic powder may be pressed powder cake according to conventional practice, in which case it may include may include a binder (e.g., powder, liquid, or oils binders) to facilitate adhesion of the particles into a unitary cake.

The cosmetic powder compositions of the invention are particularly effective in delivering active agents to keratinous surface such as the skin. Such active agents may be transferred from the compositions of the invention to a keratinous surface by, for example, by contacting the keratinous surface with the powder, or by rubbing or pressing the powder topically onto the keratinous surface. The active agent or agents in the cosmetic powder compositions of the invention may comprise, for example, one or more of antioxidants, alpha-hydroxy acids, beta-hydroxy acids, retinoids, humectants, organic sunscreens, depigmenting agents, desqumating agent, anti-acne agents, anti-cellulite agents, collagenase inhibitors, elastase inhibitors, collagen stimulators, elastin stimulators, thiodipropionic acid and esters thereof, glycolic acid, N-Acetyl Tyrosinamide, and other anti-aging ingredients.

An antioxidant functions, among other things, to scavenge free radicals from skin, protecting the skin from environmental aggressors. Examples of antioxidants that may be used in the compositions of the invention include compounds having phenolic hydroxy functions, such as ascorbic acid and its derivatives/esters; thiodipropionic acid and its esters; vitamins A, C, or E; polyphenols, beta-carotene; catechins; curcumin; ferulic acid derivatives (e.g. ethyl ferulate, sodium ferulate); gallic acid derivatives (e.g., propyl gallate); lycopene; reductic acid; rosmarinic acid; tannic acid; tetrahydrocurcumin; tocopherol and its derivatives; uric acid; or any mixtures thereof. Other suitable antioxidants are those that have one or more thiol functions (-SH), in either reduced or non-reduced form, such as glutathione, lipoic acid, thioglycolic acid, and other sulfhydryl compounds. The antioxidant may be inorganic, such as bisulfites, metabisulfites, sulfites, or other inorganic salts and acids containing sulfur. Compositions of the present invention may have an antioxidant preferably from about 0.001 weight % to about 10 weight %, and more preferably from about 0.01 weight % to about 5 weight %, based on the total weight of the composition.

Suitable retinoids include, without limitation, retinoic acid (e.g., all-trans or 13-cis), derivatives thereof, and salts thereof, retinaldehyde, retinol (Vitamin A) and esters thereof, such as retinyl palmitate, retinyl acetate and retinyl propionate. Retinoids may comprise from about 0.001 weight % to about 10 weight %, and more typically from about 0.01 weight % to about 5 weight %, based on the total weight of the composition or formulation.

Hydroxy acids may include, for example, alpha-hydroxy acids and beta-hydroxy acids.

Any anti-acne agents may be used in the cosmetic powder compositions of the invention, including, for example, salicylic acid, alkyl salicylates, triclosan, benzoyl peroxide and other peroxides, sulfur and the like.

Desquamating agents may include, for example, salicylic acid.

Suitable anti-cellulite agents may include, for example, perilla oil and other unsaturated fatty oils and omega-3 fatty acids such as alpha-linolenic acid; caffeine; theophylline; xanthines; retinoids (e.g., retinol); and the like.

The active agents in the compositions of the invention may also be dipigmenting agents that are useful for treating hyperpigmentation or otherwise unwanted pigmentation. Suitable depigmenting agents may include, for example, tyrosinase inhibitors and/or melanosome transfer inhibitors. In particular, the suitable depigmenting agents may include thiodipropionic acid and esters thereof (notably, di-lauryl esters); hydroquinone and the monobenzyl ether thereof; hydroquinone-beta-D-glucopyranoside; retinoids (e.g., retinoic acid); tretinoin; azelaic acid; Kojic acid (5-hydroxy-4-pyran-4-one-2-methyl); Mequinol (4-hydroxyanisole); Niacinamide; soy protein and other serine protease inhibitors; paper mulberry extract; Glabridin (licorice extract); Arctostaphylos patula and Arctostaphylos viscida extracts; Magnesium-L-ascorbyl-2-phosphate (MAP); 4-Isopropylcatechol; Aleosin; N-acetyl-4-S-cysteaminylphenol and N -propionyl-4-S-cysteaminylphenol; N-acetyl glucosamine; and Tranexamic acid (trans -4-aminomethylcyclohexanecarboxylic acid); to name a few.

Suitable humectants may include, for example, glycerin, caprylyl glycol, or polyols.

Collagen or elastin stimulators are effective in, for example, providing improvement in procollagen and/or collagen production and/or improvement in maintenance and remodeling of elastin. A compound or substance is determined to be a collagen and/or elastin upregulator by, for example, assaying keratinocytes and/or fibroblasts of the skin and determining whether the candidate substance upregulates cellular mRNA encoding collagen and/or elastin.

Suitable anti-aging agents may include, without limitation, botanicals (e.g., Butea frondosa extract); phytol; thiodipropionic acid (TDPA) and esters thereof; retinoids, exfoliating agents (e.g., glycolic acid, 3,6,9-trioxaundecanedioic acid, etc.), estrogen synthetase stimulating compounds (e.g., caffeine and derivatives); compounds capable of inhibiting 5 alpha-reductase activity (e.g., linolenic acid, linoleic acid, finasteride, and mixtures thereof); and barrier function enhancing agents (e.g., ceramides, glycerides, cholesterol and its esters, alpha-hydroxy and omega-hydroxy fatty acids and esters thereof, etc.), to name a few.

The active agents of the compositions may also include exfoliation promoters. Suitable examples of exfoliation promoters include alpha hydroxy acids (AHA); benzoyl peroxide; beta hydroxy acids; keto acids, such as pyruvic acid, 2-oxopropanoic acid, 2-oxobutanoic acid, and 2-oxopentanoic acid; oxa acids as disclosed in U.S. Pat. Nos. 5,847,003 and 5,834,513 (the disclosures of which are incorporated herein by reference); salicylic acid; urea; or any mixtures thereof. Some preferred exfoliation promoters are 3,6,9-trioxaundecanedioic acid, glycolic acid, lactic acid, or any mixtures thereof. When an embodiment of the invention includes an exfoliation promoter, the composition may have from about 0.1 weight % to about 30 weight %, preferably from about 1 weight % to about 15 weight %, and more preferably from about 1 weight % to about 10 weight %, of the exfoliation promoter based on the total weight of the composition.

Additional actives agents may, include botanicals, keratolytic agents, keratinocyte proliferation enhancers, anti-inflammatory agents, steroids, desthiobiotin, piperazine carboxamide, cis-6-nonenol, caffeine, arginine, glucosamine, algae extract, chlorphenesin, advanced glycation end-product (AGE) inhibitors, and PLOD-2 stimulators (e.g., N-acetyl amino acid amides, such as N-Acetyl Tyrosinamide).

Suitable botanicals include, without limitation, Abies pindrow, Abrus fruticulosus, Acacia catechu, Acacia melanoxylon, Alisma orientate, Amorphophallus campanulatus, Anogeissus latifolia, Archidendron clypearia, Asmunda japonica, Averrhoa carambola, Azadirachta indica, Berchemia lineate, Breynia fruticosa, Butea frondosa, Butea monosperma, Caesalpinia sappan Linn, Calatropis gigantean, Cayratia japonica, Cedrus deodara, Celosia argentea, Cistanche tubulosa, Clerodendron fragrans, Clerodendrum floribundum, Clinacanthus nutans, cola, Commersonia bartramia, Dendranthema indicum, Derris scandens, Desmanthus illinoensis, Dianella ensifolia, Dodonaea viscose, Duboisa myoporoides, Eclipta prostrate, Ehretia acuminate, Emblica officinalis, Erthrina Flabelliformis, Erythina indica, Fibraretinum resica Pierre, Ficus benghalensis, Ficus coronata, forskohlii, Ginkgo biloba, Glycyrrhiza glabra, Gomphrena globosa Linn, Goodenia ovata, Gynandropsis gynandra, hawthorne, Helichrysum Odoratissimum, Heliotropium indicum, Humulus japonicus, Hymenosporum flavum, Ilex purpurea Hassk, Innula racemosa, Ixora chinensis, Justicia ventricosa, Lavatera plebeian, Ligusticum chiangxiong, Ligusticum lucidum, Loropetalum chinense, Maesa japonica, Mallotus philippinensis, Mammea siamensis, Medemia nobilis, Melaleuca quinquernervia, Melicope hayesii, Mimusops elengi, Morinda citrifolia, Moringa oleifera, Naringi crenulata, Nerium indicum, Omolanthes populifolius, Operculina turpethum, Orthosiphon grandiflorus, Ozothamnus Obcordatus, Physalis minima, Portulaca oleracea, Pouzolzia pentandra, Psoralea corylifolia, Pteris semipinnata, Raphia farinifera, Sambucus chinensis, Sapindus rarak, Scoparis dulcis, Sesbania grandiflora, Stenoloma chusana, Tagetes erecta Linn, Terminalia bellerica, Tiliacora triandra, tomato glycolipid, Vernonia cinerea Linn. Less, yohimbine, aloe, chamomile, and combinations thereof.

A skin plumper serves as a collagen enhancer to the skin. A suitable skin plumper, for example, is palmitoyl oligopeptide. Other skin plumpers may include collagen and/or glycosaminoglycan (GAG) enhancing agents. The skin plumper is preferably present from about 0.1 weight % to about 20 weight % of the total weight of the composition or formulation.

The cosmetic powder compositions of the invention may be in the form of face powders, eye shadows, mineral powders, pressed powder, loose powder, mosaic powder, multi-color powder, powder blush, powder foundation, body talc powder, fragrance talc powder, or other powder-based cosmetic or personal care product. The cosmetic powder compositions are applied to the keratinous surface in the conventional manner, that is by sprinkling, rubbing coating or otherwise contacting the surface with the composition, which is intended to remain on the surface for a period of time, typically for at least one hour, for two hours, for three hours, for four hours, or even longer.

In a preferred embodiment, the composition is in the form of a pressed powder cake. The powder cake may include a binder the adhere the particles into a unitary mass. The binders for forming a powder cake include, without limitation powder binders, which are solid (non-liquid) materials. Powder binders may include, for example, sodium stearyl fumarate, zinc stearate, magnesium stearate, and calcium stearate. The binders for forming a powder cake include, without limitation, liquid binders, including silicone oils (e.g., dimethicones, dimethicone copolyols, etc.), hydrocarbons (e.g., mineral oil; paraffin oil; petrolatum; squalane, polybutene and other polyolefins; dodecane, isododecane, hexadecane, isohexadecane, eicosane, isoeicosane, tridecane, tetradecane and other C₁₂₋₃₆ hydrocarbons), ester oils (e.g., caprylic/capric acid triglyceride, etc.), and vegetable oils (e.g., castor oil, jojoba oil, etc.), waxes, lanolin, liquid lanolin, to name a few.

### EXAMPLES

The following examples describe specific aspects of the invention to illustrate the invention but should not be construed as limiting the invention, as the examples merely provide specific methodology useful in the understanding and practice of the invention and its various aspects.

### Example 1

### Tape Stripping

The efficiency and effectiveness of the delivery of an active, caffeine, by the compositions of the current invention was evaluated using a tape stripping experiment. An eye shadow composition was prepared in accordance with the current invention using the formulation detailed within Table 1.

TABLE 1
EYE SHADOW COMPONENTS

| | Amount |
|---|---|
| | (Wt. %) |
| Fillers | |
| Talc | 6.00 |
| Lauroyl Lysine | 1.00 |
| Boron Nitride | 6.00 |
| Synthetic Fluorphlogopite | 10.00 |
| Mica Magnesium Myristate | 16.00 |
| Total Fillers | 33.00 |
| Powder Binders | |
| Magnesium Myristate | 4.0 |
| Total Powder Binders | 4.0 |
| Pigments/Pearls | |
| Pigments | 0.20 |
| Pearlescent Pigments | 45.50 |
| Total Pigment/Pearls | 45.70 |
| Active Ingredient | |
| Caffeine | 2.0 |
| Total Active Ingredient | 2.0 |
| Liquid Solvent for Active | |
| Squalene | 2.00 |
| Cholesterol Esters | 2.20 |
| Myristyl Myristate | 2.64 |
| Isononyl Isononanoate | 7.25 |
| Total Liquid Solvent for Active | 14.10 |
| Preservatives | |
| Caprylyl Glycol | 1.00 |
| Disodium EDTA | 0.20 |
| Total Preservatives | 1.20 |

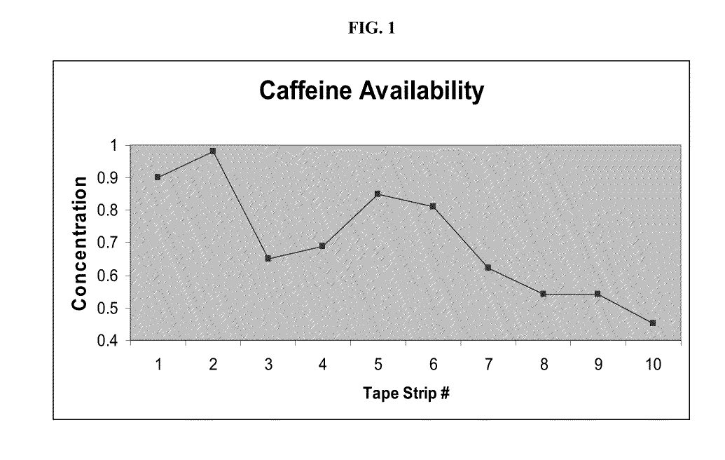

The eye shadow composition was prepared by mixing the fillers, powder binder, pigments (excluding pearls), active ingredient, and dry preservative (Disodium EDTA). A premix of the liquid solvent for the active with the solid preservative (Caprylyl Glycol) was also prepared by mixing at temperature of 55° C. The powder pre-mix and liquid solvent for the active/ preservative pre-mix were sprayed and then processed in a hammer mill. The pearlescent pigments were then mixed into the composition. The tape stripping test was performed by applying the above-noted eye shadow composition to the forearm of a test subject. The eye shadow composition remained on the forearm for a period of four (4) hours at which time the eye shadow composition was removed from the forearm using a cleaning solution. A 1 inch circular Dsquame tape strip (Strip #1) was applied to the area of the forearm and was smoothed out using hand pressure. The tape was then removed in one fluent motion. Portions of the skin, the stratum corneum—the outer layer of the epidermis specifically, are attached to the tape after removal. Nine more strips of tape (Strips 2-10) were applied and removed from the same area of the forearm in sequence. The stratum corneum on each of the tape strips was tested for the concentration of caffeine contained therein. The results are depicted in FIG. 1, clearly illustrating that the active ingredient penetrated into the stratum corneum.

### Example 2

### Franz Cell Experiment

A Franz Cell experiment was conducted to determine the penetration of actives from cosmetic compositions of the current invention into an integument. Five formulations were prepared. A control formulation of water and 10% glycerin, a first filler only composition of talc and 10% glycerin, and a second filler only composition of Nylon powder and 10% glycerin were prepared. A negative control of a finished powder base without oil having the formulation of Table 2 listed below was prepared.

TABLE 2
NEGATIVE CONTROL COMPOSITION

| | Amount |
|---|---|
| | (Wt. %) |
| Fillers | |
| Talc | 49.89 |
| Nylon Powder | 0.76 |
| Treated Talc | 1.40 |
| Sericite | 13.00 |
| Treated Sericite | 13.74 |
| Silica | 0.40 |
| Total Fillers | 79.19 |
| Powder Binders | |
| Zinc Stearate | 0.01 |
| Total Powder Binders | 0.01 |
| Pigments/Pearls | |
| Pigments | 2.00 |
| Pearlescent Pigments | 10.00 |
| Total Pigment/Pearls | 12.00 |
| Active Ingredient | |
| Glycerin | 7.50 |
| Total Active Ingredient | 7.50 |
| Preservatives | |
| Caprylyl Glycol/Phenoxyethanol Blend | 1.00 |
| Disodium EDTA | 0.20 |
| Tetrasodium EDTA | 0.10 |
| Total Preservatives | 1.30 |
| TOTAL | 100.00 |

The cosmetic composition of Table 2 was prepared by mixing the fillers, powder binder, pigments (excluding pearls), and dry preservatives (D-EDTA & T-EDTA). A premix of the liquid preservative (Caprylyl Glycol) and active ingredient was also prepared by mixing. The powder pre-mix was then combined with the preservative pre-mix through spray drying and further processed in a hammer mill. The pearlescent pigment was then added with mixing.

A composition in accordance with current having the formulation of Table 3 was prepared.

TABLE 3
INVENTIVE COMPOSITION

| | Amount |
|---|---|
| | (Wt. %) |
| Fillers | |
| Talc | 43.89 |
| Nylon Powder | 5.76 |
| Treated Talc | 1.40 |
| Sericite | 13.00 |
| Treated Sericite | 13.74 |
| Silica | 0.40 |
| Total Fillers | 78.19 |
| Powder Binders | |
| Zinc Stearate | 0.01 |
| Total Powder Binders | 0.01 |
| Pigments/Pearls | |
| Pigments | 2.00 |
| Pearlescent Pigments | 10.00 |
| Total Pigment/Pearls | 12.00 |
| Liquid Solvent for Active | |
| Isopropyl Isostearate | 3.05 |
| C12-15 Alcohol Benzoate | 1.70 |
| Total Liquid Solvent for Active | 4.75 |
| Active Ingredient | |
| Glycerine | 3.75 |
| Total Active Ingredient | 3.75 |
| Preservatives | |
| Caprylyl Glycol/Phenoxyethanol Blend | 1.00 |
| Disodium EDTA | 0.20 |
| Tetrasodium EDTA | 0.10 |
| Total Preservatives | 1.30 |

The inventive cosmetic composition of Table 3 was prepared by mixing the fillers, powder binder, pigments (excluding pearls), and dry preservatives (D-EDTA & T-EDTA). A premix of the liquid solvent for the active with liquid preservative (Caprylyl Glycol) and active ingredient was also prepared by mixing. The powder pre-mix was then combined with the liquid solvent for the active/preservative pre-mix through spray and then processed in a hammer mill. The pearls were then mixed into the composition.

The relative permeation of the active ingredient, glycerin, from each of the five compositions: the control, first filler, second filler, negative control, and inventive composition were tested within a Franz Diffusion Cell apparatus. The Franz Diffusion Cell apparatus has a donor chamber positioned over a receptor chamber with a membrane, which in this case was Invetro skin, positioned between the two chambers. The donor chamber contains the composition to be tested and positions the composition over the membrane. The receptor chamber is filled with water heated to between 37° C. to 40° C. using means such as a water jacket with a water jacket and heater/circulator . At predetermined periods the water from the receptor chamber may be sampled through the sampling port.

The compositions of the current example were charged into the donor chamber of the Franz Cell apparatus on top of the membrane. The receptor chamber was filled with water at 40° C. and the apparatus was allowed to stand for a period of four (4) hours. The receptor chamber was then drained of water and the concentration of the active within the water was determined using gas chromatograph mass spectrometer (GCMS). The results of the Franz Cell experiment are illustrated in Table 4 below and clearly demonstrate that the current powdered composition provides for enhanced delivery of actives.

TABLE 4
Results of Franz Cell

| | | Conc. (mg/ml)/ | % per |
|---|---|---|---|
| | | glycerin in | control |
| Formula | Description | formula* | level |
| Control (Water + 10% | Water Dispersion | 4.2 | 100% |
| Glycerin) | | | |
| Negative Control | Contains no Liquid | 1.06 | 25% |
| Composition (Table 2) | Solvent for Active | | |
| Inventive Composition | With Liquid Solvent | 6.1 | 146% |
| (Table 3) | for Active | | |

*Levels of glycerin found to penetrate were normalized given that the different formulas contained different levels of glycerin.

All references including patent applications and publications cited herein are incorporated herein by reference in their entirety and for all purposes to the same extent as if each individual publication or patent or patent application was specifically and individually indicated to be incorporated by reference in its entirety for all purposes. Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A cosmetic powder composition comprising talc or mica particles having dispersed thereon an active agent and a liquid solvent for said active agent, the weight ratio of said particles to said liquid solvent being about 9:1 to about 30:1, wherein said cosmetic powder composition is in the form of a free flowing powder or a pressed powder cake, and wherein the composition is capable of transferring effective amounts of said active agents upon applying the powder topically on a keratinous surface.

2. The cosmetic powder composition according to claim 1, wherein the powder retains free-flowing characteristics.

3. The cosmetic powder composition according to claim 1, wherein the composition is in the form of a pressed powder cake.

4. The cosmetic powder according to claim 1, wherein said solvent comprises one or more of a polyterpene oil, a fatty ester oil, a salicylate ester, or a benzoate ester.

5. The cosmetic powder according to claim 4, wherein said polyterpene oil is squalene.

6. The cosmetic powder according to claim 4, wherein said fatty ester oil is selected from the group consisting of isononyl isononoate, isopropyl isostearate, and mixtures thereof.

7. The cosmetic powder according to claim 4, wherein said benzoate ester is C₁₂₋₁₅ alkyl benzoate.

8. The cosmetic composition according to claim 1, where said cosmetic powder includes mica particles.

9. The cosmetic composition according to claim 1 wherein said liquid is sprayed onto said talc or mica particles.

10. The cosmetic composition according to claim 1 wherein said liquid is mixed with said talc or mica particles under high shear or by milling.

11. The cosmetic composition according to claim 9 wherein the active agent is dissolved in said liquid prior to contacting said particles with said liquid.

12. The cosmetic composition according to claim 10 wherein the active agent is dissolved in said liquid prior to contacting said particles with said liquid.

13. The cosmetic powder composition according to claim 1, wherein the weight ratio of said particles to said liquid solvent is about 15:1 to about 25:1.

14. The cosmetic powder composition according to claim 1, wherein the weight ratio of said particles to said liquid solvent is about 18:1 to about 22:1.

15. The cosmetic powder composition according to claim 1, wherein said active agent is selected from the group consisting of antioxidants, alpha-hydroxy acids, beta-hydroxy acids, retinoids, humectants, organic sunscreens, depigmenting agents, desquamating agent, anti-acne agents, anti-cellulite agents, collagenase inhibitors, elastase inhibitors, collagen stimulators, elastin stimulators, thiodipropionic acid and esters thereof, glycolic acid, N-Acetyl Tyrosinamide, and other anti-aging ingredients.
